(19) United States
(12) Patent Application Publication
(10) Pub. No.: US 2003/0219618 A1
(43) Pub. Date: Nov. 27, 2003

(54) Ribbed die cast product

(76) Inventors: Yusuke Toyoda, Wako-shi (JP); Katsuhiro Shibata, Wako-shi (JP); Tsunehisa Hata, Wako-shi (JP); Fumiaki Fukuchi, Wako-shi (JP); Takahiro Mizukami, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/392,391

(22) Filed: Mar. 20, 2003

(30) Foreign Application Priority Data
Mar. 27, 2002 (JP) 2002-087514

(51) Int. Cl. B32B 1/00

(52) U.S. Cl. 428/598; 428/600

(57) ABSTRACT

A ribbed die cast product includes a plate-shaped main body and at least one rib provided on a back surface of the main body. The die cast product is made of an Al—Mg alloy. A first imaginary straight line runs along a lengthwise direction of the rib and intersects a plurality of second imaginary straight lines that run along the flow of molten metal in the main body.

### BACKGROUND OF THE INVENTION

1. Field of the Invention

The present invention relates to a ribbed die cast product. In particular, the present invention relates to a ribbed die cast product formed from an Al-Mg alloy and having a plate-shaped main body with at least one rib provided on a back surface of the main body.

2. Discussion of the Related Art

Conventionally, it is well known that in a large, thin casting, such as, for example, an automobile door panel, at least one reinforcement rib is provided on a back surface of a plate-shaped main body. Furthermore, it is also well known that an alloy made of aluminum-magnesium (Al—Mg) has excellent strength and toughness, and thus is a fairly desirable material from which to form such large, thin castings.

However, since the composition of such an Al—Mg alloy has poor flowability in a molten state, when such large, thin castings are die cast, it is necessary to use high speed filling molding to avoid the occurrence of casting defects, such as, for example, incomplete filling.

Under such circumstances, if a direction of molten metal flow in such a plate-shaped main body, that is, a region of a die cavity used to mold the plate-shaped main body, is made to coincide with the lengthwise direction of a rib, that is, a region of the die cavity used to mold the rib, the molten metal is cooled by the die and solidifies at an early stage on the flow front side of the rib molding region. However, on the base side of such a rib molding region, since the molten metal flows at a high speed and a relatively large volume, a section of the die corresponding to the base overheats. As a result, the rib base side is the last part to solidify. Accordingly, an Al—Mg eutectic intermetallic compound, an Mn intermetallic compound, and the like disadvantageously segregate and a shrinkage cavity is disadvantageously formed.

### SUMMARY OF THE INVENTION

It is an object of the present invention to overcome the above-described deficiencies of the recited art.

It is also an object of the present invention to provide a ribbed die cast product having substantially improved casting qualities on the rib base side.

It is yet another object of the present invention to provide a ribbed die cast product having sound casting qualities throughout the entire product with superior strength and toughness.

In order to achieve these and other objects, the present invention provides a ribbed die cast product made from an Al-Mg alloy having a plate-shaped main body with at least one rib provided on a back surface of the main body, wherein a first imaginary straight line running along a lengthwise direction of the rib intersects a second imaginary straight line running along a molten metal flow in the main body.

With the above-described arrangement, molten metal that fills a rib molding region of a die cavity has difficulty flowing toward a plate-shaped main body molding region because it has poor flowability. As a result, the flow of the molten metal in the base part of the rib molding region is suppressed and the molten metal in the base part is able to solidify at an early stage. It is thus possible to provide a ribbed die cast product in which the occurrence of casting defects in the rib base part is significantly suppressed.

Furthermore, setting an intersection angle (a) between the first and second imaginary straight lines within a range of 25≦α≦90° further suppresses the occurrence of casting defects, and improves the strength and toughness of the rib base part compared to when the intersection angle a is less than 25°.

Moreover, with regard to the Al—Mg alloy, it is preferable to use an alloy that includes: 3.5 wt %≦Mg≦4.5 wt %; Si≦0.25 wt %; 0.8 wt %≦Mn≦1.5 wt %; Fe≦0.5 wt %; 0.1 wt %≦Ti≦0.3 wt %; and the balance being Al including inevitable impurities. The Al—Mg alloy is able to provide a ribbed die cast product having a high quality without filling defects and the like and providing excellent strength and toughness.

Each of the above-listed chemical components is provided for reasons that are described below.

For example, with regard to magnesium (Mg), this chemical component contributes to improving the strength and toughness of the die cast product. However, when less than 3.5 wt % Mg is used, the flowability of the molten metal deteriorates. Furthermore, when more than 4.5 wt % Mg is used, the toughness of the die cast product degrades, and an Al—Mg eutectic intermetallic compound segregates in a section where solidification is delayed, thereby resulting in undesirable casting cracks.

With regard to silicon (Si), the chemical component contributes to improving the overall strength of the die cast product. However, when more than 0.25 wt % Si is used, the formation of an Mg₂Si intermetallic compound is accelerated, which degrades the toughness of the die cast product.

With regard to manganese (Mn), since the alloy has a low iron (Fe) content in order to maintain the toughness of the die cast product and a relatively high melting point, it is easily sintered on the surface of a die. Mn is a chemical component that contributes to improving the resistance to sintering and is indispensable for high speed filling casting of large, thin die cast products. Also, Mn improves overall strength of the product. However, when less than 0.8 wt % Mn is used, the sintering resistance of the alloy deteriorates. Likewise, when more than 1.5 wt % Mn is used, although the strength of the die cast product improves, the overall toughness thereof degrades and the flowability of the molten metal deteriorates.

With regard to iron (Fe), the chemical component contributes to improving the strength of the die cast product, but when more than 0.5 wt % Fe is used, Fe-based crystals are formed, which degrade the toughness of the die cast product.

With regard to titanium (Ti), the chemical component prevents the occurrence of casting cracks by making the metal structure of the die cast product finer, and contributes to improving the flowability of the molten metal. However, when less than 0.1 wt % Ti is used, the metal structure is not sufficiently fine and as a result, the flowability of the molten metal deteriorates. When more than 0.3 wt % Ti is used, Ti—Al high-temperature crystals degrade the flowability of the molten metal. Zirconium (Zr) has the same effects as those of Ti. Furthermore, when 0.02 wt %≦B≦0.04 wt % is used, the boron (B) promotes the effect of making the metal structure fine while coexisting with with Ti and Zr.

### BRIEF DESCRIPTION OF THE DRAWINGS

Other objects, features and advantages of the present invention will be more readily appreciated from the following detailed description and claims when taken together with the accompanying drawings, wherein:

FIG. 1 is a perspective view of a back surface of a ribbed die cast product;

FIG. 2 is a cross section along line 2-2 in FIG. 1;

FIG. 3 is a front view of an essential part of a fixed die half;

FIG. 4 is a cross sectional view taken along line 4-4 in FIG. 3, which corresponds to a cross section of the die;

FIG. 5 is a front view of an essential part of a fixed die half when an intersection angle αis 0°;

FIG. 6 is a front view of an essential part of a fixed die half when the intersection angle α is 20°;

FIG. 7 is a front view of an essential part of a fixed die half when the intersection angle α is 25°;

FIG. 8 is a front view of an essential part of a fixed die half when the intersection angle α is 60°;

FIG. 9 is a front view of an essential part of a fixed die half when the intersection angle α is 90°;

FIG. 10 is a graph illustrating the relationship of the intersection angle α relative to tensile strength and elongation;

FIG. 11 is a graph illustrating the relationship of the Mg content relative to elongation and flow length;

FIG. 12 is a graph illustrating the relationship between the Si content and elongation;

FIG. 13 is a graph illustrating the relationship of the Mn content relative to tensile strength and elongation;

FIG. 14 is a graph illustrating the relationship between the Fe content and elongation; and

FIG. 15 is a graph illustrating the relationship between the Ti content and flow length.

### DETAILED DESCRIPTION OF THE PREFERRED EMBODIMENTS

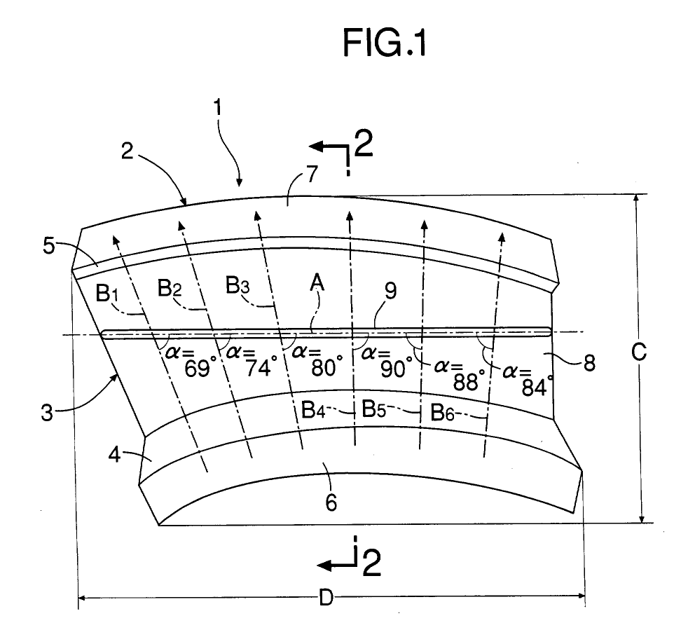

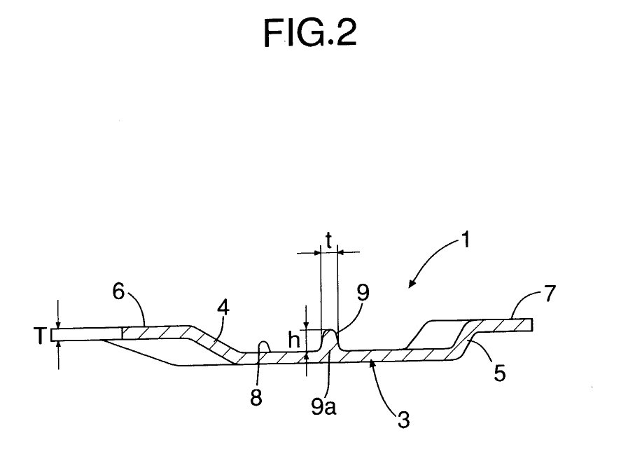

FIG. 1 is a perspective view of a ribbed die cast product 1 seen from a back side. As also shown in FIG. 2, the die cast product 1 has a plate-shaped main body 2, having a relatively flat portion 3, a relatively wide first bent portion 4, a relatively narrow second bent portion 5, and first and second outer edge portions 6 and 7. Opposite edges of the flat portion 3 in the lengthwise direction have a substantially arc-shaped form. The first and second bent portions 4 and 5, respectively, are connected to opposite edges of the flat portion 3 and bend in the same direction relative to the flat portion 3. The first and second outer edge portions 6 and 7 are connected to the outer edges of the first and second bent portions 4 and 5, respectively, and are substantially parallel relative to the flat portion 3. In the illustrated embodiment, at least one straight rib 9 is provided on a back surface 8 of the flat portion 3, wherein the rib 9 divides the back surface 8 into two substantially equal sections along the lengthwise direction. The die cast product 1 is made of an Al—Mg alloy.

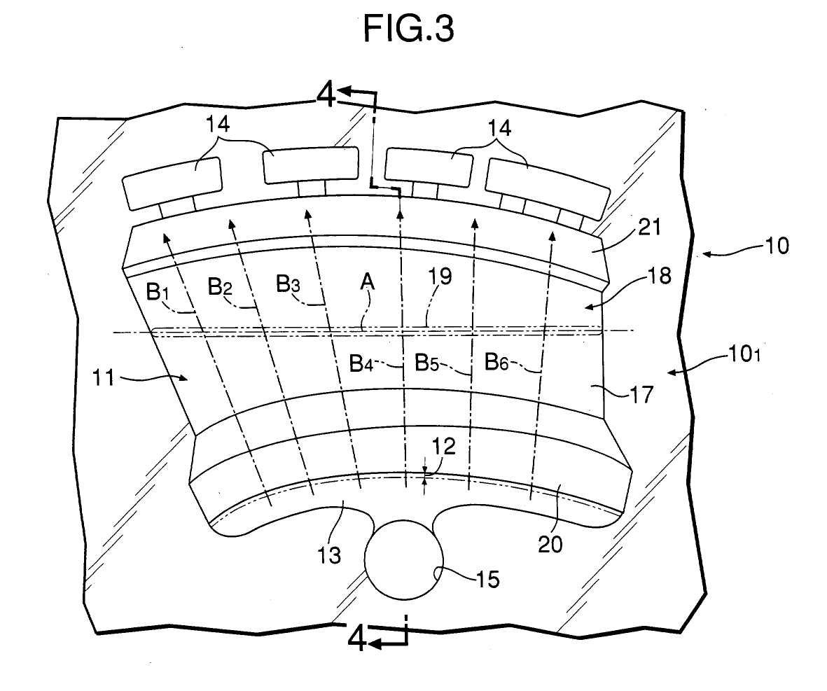

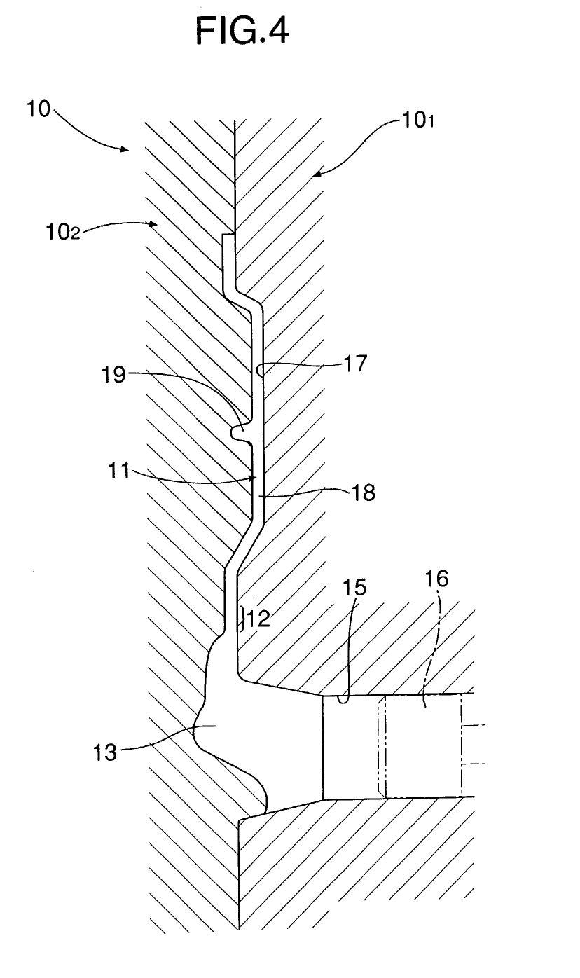

As shown in FIGS. 3 and 4, a die 10 used to cast the die cast product 1 is formed from a fixed die half 101 and a movable die half 102. A cavity 11 used to mold the die cast product 1, a thin or edge gate 12, a runner 13, and a plurality of overflow parts 14 are formed between the two die halves 101 and 102. In the fixed die half 101, a pressure plunger 16 is slidably fitted in a cylinder hole 15 that communicates with the runner 13. In the cavity 11, a molding surface 17 of the fixed die half 101 forms a front surface of the plate-shaped main body 2. Therefore, a plate-shaped main body molding region 18 of the cavity 11 is present on the fixed die half 10, side, and a straight rib molding region 19 is present on the movable die half 102 side.

The thin or edge gate 12 is formed to extend along an entire length of an outer edge of a first outer edge portion molding section 20 of the plate-shaped main body molding region 18. The runner 13 communicates therewith throughout its whole length. The plurality of overflow parts 14 are positioned at predetermined intervals along an outer edge of a second outer edge portion molding section 21 of the plate-shaped main body molding region 18.

During casting, when the cavity 11 is filled with a molten Al—Mg alloy composition at high speed via the thin or edge gate 12, a substantially radial flow of the molten metal occurs within the cavity 11. As a result, as shown in FIG. 3, a plurality of second imaginary straight lines B₁ to B₆ along a molten metal flow direction in the plate-shaped main body molding region 18 intersects a first imaginary straight line A that runs along the direction in which the straight rib molding region 19 extends, that is, the lengthwise direction of the die 10.

When such an intersecting relationship is satisfied, the molten metal filling the straight rib molding region 19 of the cavity 11 has difficulty flowing toward the plate-shaped main body molding region 18 of the cavity 11 because the molten metal has poor flowability. As a result, the flow of molten metal in a base part of the straight rib molding region 19 is suppressed, and the molten metal solidifies at an early stage on the flow front side of the straight rib molding region 19 and in the base part.

The intersecting relationship in the ribbed die cast product 1 is such that, as shown in FIG. 1, the plurality of second imaginary straight lines B₁ to B₆ along the molten metal flow direction in the plate-shaped main body 2 each intersect the first imaginary straight line A running along the direction in which the straight rib 9 extends, that is, the lengthwise direction of the die 10. Therefore, under the above structural restriction, casting defects are substantially suppressed in a base portion 9a of the straight rib 9 in the ribbed die cast product 1.

The direction in which the molten metal flows in the plate-shaped main body 2 can be found from the position of the thin or edge gate 12. However, when the position of the thin or edge gate 12 cannot be determined, the direction of flow of a die release agent transferred to the surface of the plate-shaped main body 2 is examined. The texture of the metal is examined using a microscope along the above direction of flow. It is then determined that the side where the crystal size is large is the thin or edge gate 12 side and the side where the crystal size is small is the overflow part 14 side.

When the intersection angle (i.e., smaller angle) α formed between the first and second imaginary straight lines A, B₁ to B₆ satisfies the relationship of 25°≦α≦90°, the occurrence of casting defects is substantially suppressed, and the strength and toughness of the base portion 9a of the straight rib 9 is improved relative to when the intersection angle α is less than 25°.

The intersection angles a in FIG. 1 are, from left to right, 690 for B₁, 74° for B₂, 80° for B₃, 90° for B₄, 88° for B₅, and 840 for B₆.

The range of the intersection angles a was determined experimentally as follows.

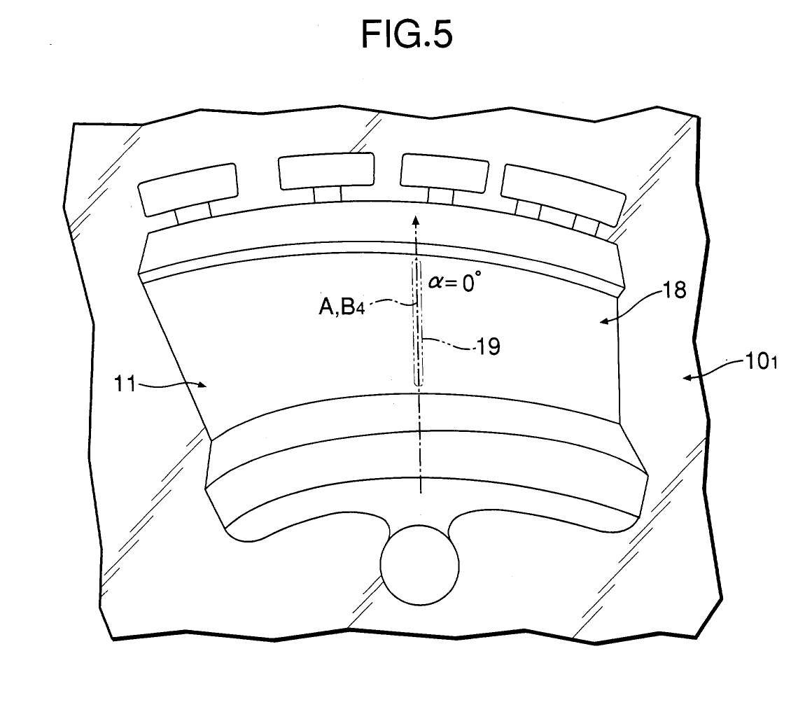

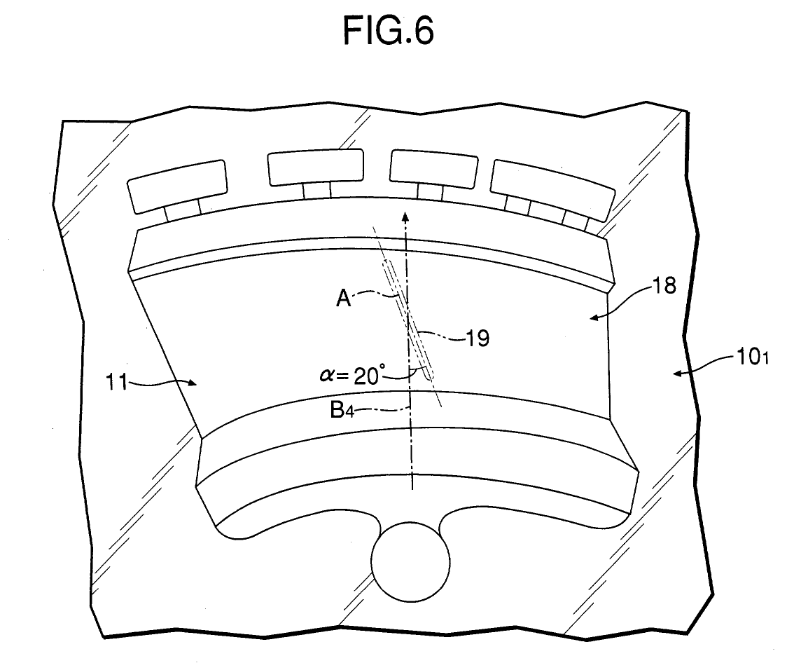

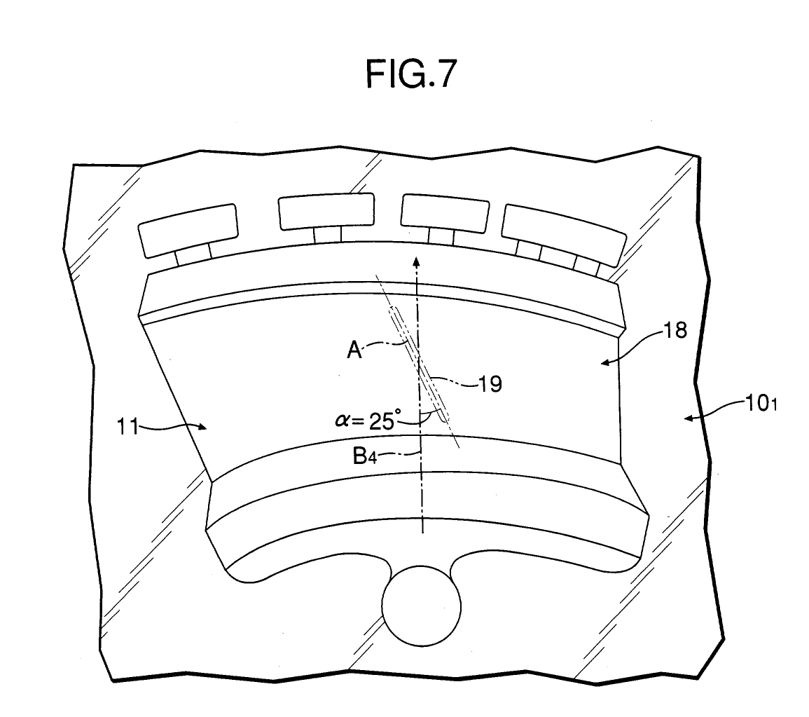

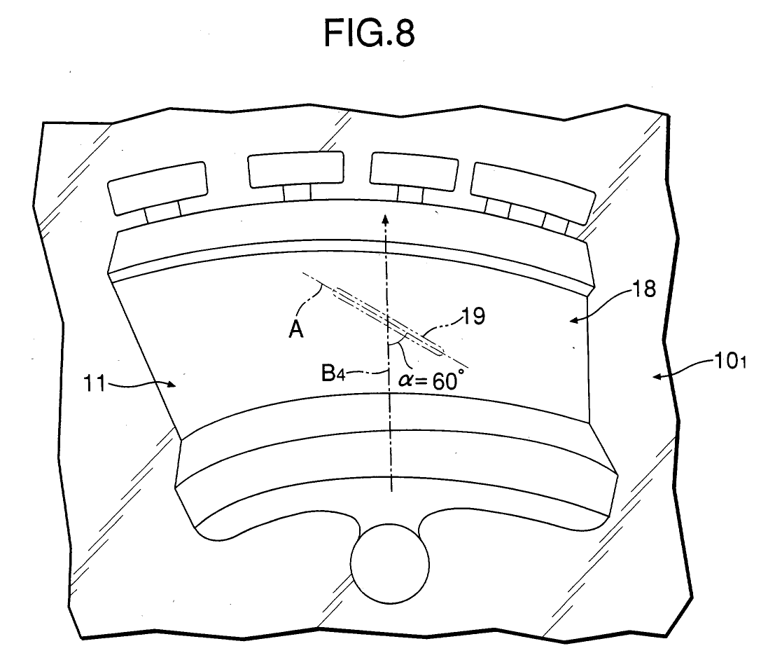

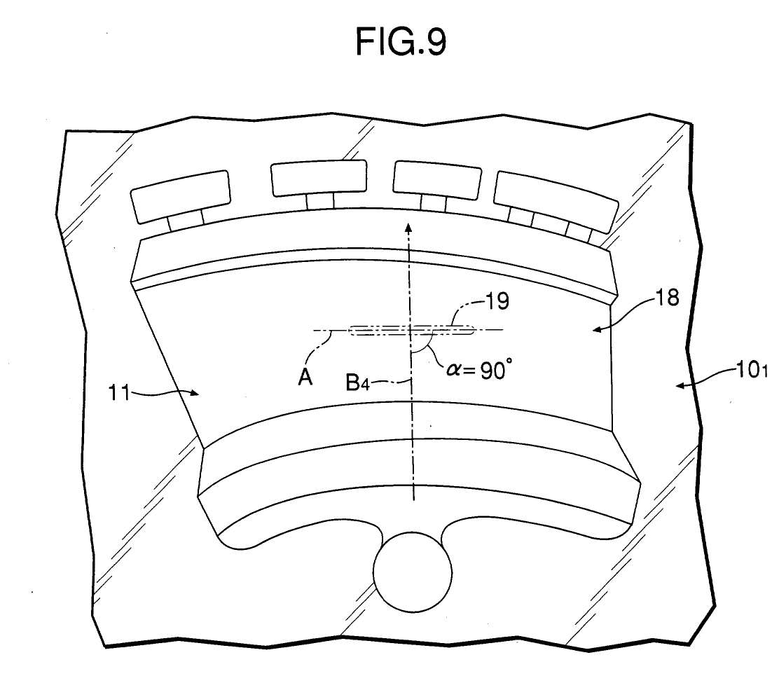

Initially, five types of movable die halves 102 were prepared in which the intersection angle α was set at 0° as shown in FIG. 5, 20° as shown in FIG. 6, 25° as shown in FIG. 7, 60° as shown in FIG. 8, and 90° as shown in FIG. 9, wherein the first imaginary straight line A of the straight rib 9 intersects the second imaginary straight line B₄, which is substantially central relative to the flow of molten metal. Also, five dies 10 were formed by combining each of the above-described movable die halves 102 with a common fixed die half 101. As shown in FIGS. 1 and 2, with regard to the die cast product 1, the dimensions of the plate-shaped main body 2 were set at 290 mm for a length C, 480 mm for a width D, and 2 mm for a thickness T. The dimensions of the straight rib 9 were set at 1.8 mm for the average thickness t and 20 mm for the height h. The Al—Mg alloy had a composition of: 4.1 wt % Mg; 0.2 wt % Si; 1.1 wt % Mn; 0.2 wt % Fe; 0.15 wt % Ti; and balance Al, including inevitable impurities.

The die 10 was then installed in a vacuum die casting machine and casting was carried out at a cavity vacuum of 6 kPa, a die temperature of 200° C. for a ceramic heat-insulating sleeve, wherein a temperature was controlled at 200° C., an injection temperature of 720° C., a low speed injection rate of 0.5 m/sec, and a high speed injection rate of 3 m/sec (i.e., converted to gate speed: 40 m/sec), to obtain the five die cast products 1.

Test pieces (a) to (e) were cut out of the base portion 9a of the straight rib 9 of each of the five die cast products 1 and subjected to a tensile test to measure tensile strength, which represents the strength, and elongation, which represents the toughness, as shown in TABLE 1.

TABLE 1

| | Intersection | Tensile | |
|---|---|---|---|
| Test | angle α | strength | Elongation |
| piece | (°) | (MPa) | (%) |
| (a) | 0 | 238 | 8.8 |
| (b) | 20 | 244 | 10.3 |
| (c) | 25 | 260 | 16.1 |
| (d) | 60 | 272 | 18.5 |
| (e) | 90 | 273 | 17.4 |

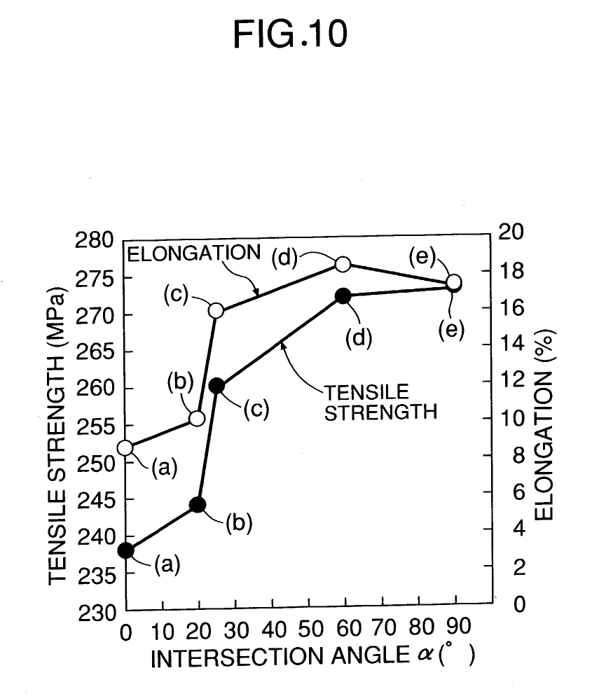

FIG. 10 is a graph illustrating the relationship of the intersection angle α relative to the tensile strength and elongation based on Table 1. It was found from TABLE 1 and FIG. 10 that increasing the intersection angle α improves the strength and toughness. The effect of these improvements is remarkable when the intersection angle α is set at 25° or larger.

The shape of the rib 9 may be an arc having a large radius.

The relationship of the chemical component content of the Al—Mg alloy to the mechanical properties of the plate-shaped main body 2 and flowability of the molten metal were then investigated. The casting conditions for the plate-shaped main body 2 were the same as above. The flow length in relation to the flowability was measured by an MIT measurement method (i.e., test temperature level 2).

(1) Relationship of Mg content to mechanical strength and flowability.

TABLE 2 shows the composition, tensile strength, elongation, and flow length at molten metal temperatures of 720° C. and 745° C. of test piece examples (1) to (7).

TABLE 2

| | Chemical components (wt %) | | | | | | | | Flow length (mm) | |
|---|---|---|---|---|---|---|---|---|---|---|
| Test piece | Mg | Si | Mn | Fe | Ti | Al | Tensile Strength (MPa) | Elongation (%) | 720° C. | 745° C. |
| (1) | 2.0 | 0.2 | 1.1 | 0.2 | 0.15 | Balance | 225 | 22.0 | 652 | 673 |
| (2) | 3.2 | 0.2 | 1.1 | 0.2 | 0.15 | Balance | 260 | 18.1 | 665 | 720 |
| (3) | 3.5 | 0.2 | 1.1 | 0.2 | 0.15 | Balance | 274 | 17.5 | 678 | 746 |
| (4) | 4.1 | 0.2 | 1.1 | 0.2 | 0.15 | Balance | 280 | 17.0 | 685 | 750 |
| (5) | 4.5 | 0.2 | 1.1 | 0.2 | 0.15 | Balance | 285 | 16.8 | 689 | 754 |
| (6) | 4.8 | 0.2 | 1.1 | 0.2 | 0.15 | Balance | 292 | 13.0 | 692 | 753 |
| (7) | 5.5 | 0.2 | 1.1 | 0.2 | 0.15 | Balance | 296 | 11.4 | 696 | 760 |

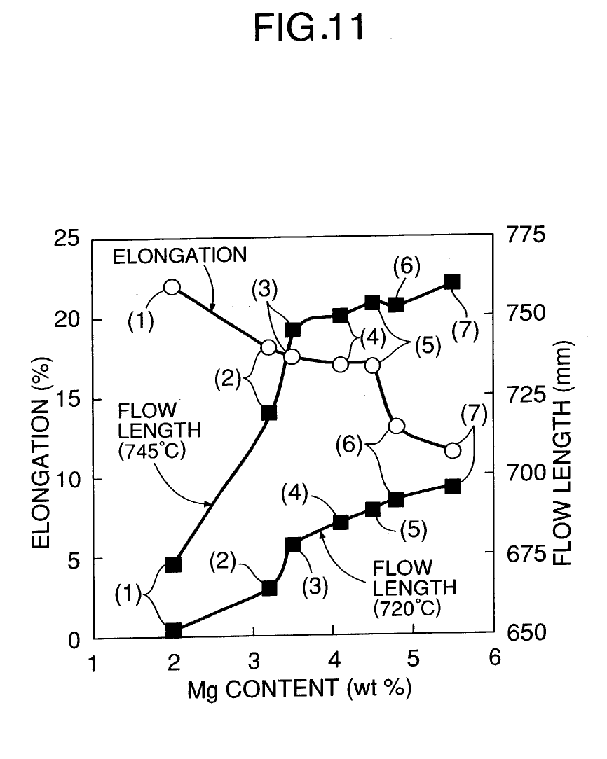

FIG. 11 is a graph illustrating the relationship of the Mg content relative to the elongation and flow length based on TABLE 2. As is clear from TABLE 2 and FIG. 11, setting the Mg content at 3.5 wt %≦Mg≦4.5 wt % prevents the occurrence of incomplete filling for the plate-shaped main body 2 and improves the strength and toughness thereof.

(2) Relationship of Si content to mechanical properties.

TABLE 3 shows the composition, tensile strength, and elongation of test piece examples (4) and (8) to (11).

TABLE 3

| | | | | | | | Tensile | |
|---|---|---|---|---|---|---|---|---|
| Test | Chemical components (wt %) | | | | | | Strength | Elongation |
| piece | Mg | Si | Mn | Fe | Ti | Al | (MPa) | (%) |
| (8) | 4.1 | 0.02 | 1.1 | 0.2 | 0.15 | Balance | 274 | 18.1 |
| (4) | 4.1 | 0.2 | 1.1 | 0.2 | 0.15 | Balance | 280 | 17.0 |
| (9) | 4.1 | 0.5 | 1.1 | 0.2 | 0.15 | Balance | 279 | 15.2 |
| (10) | 4.1 | 0.6 | 1.1 | 0.2 | 0.15 | Balance | 284 | 12.3 |
| (11) | 4.1 | 1.0 | 1.1 | 0.2 | 0.15 | Balance | 285 | 11.1 |

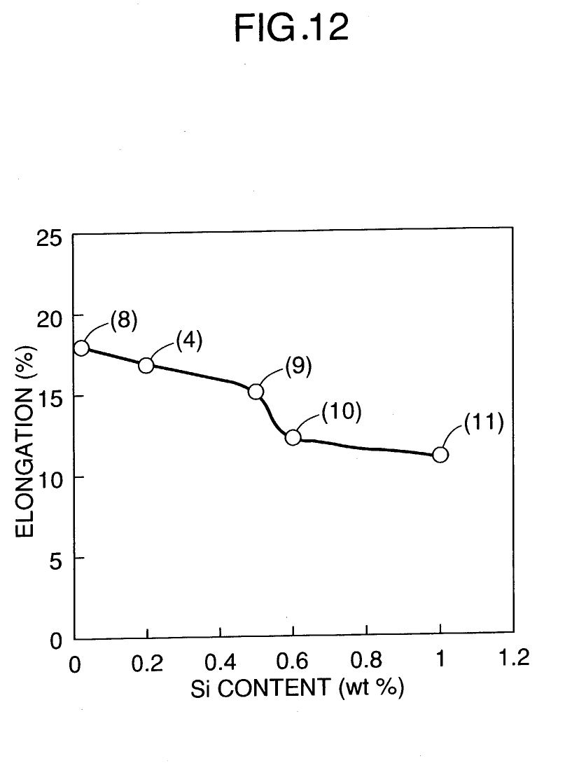

FIG. 12 is a graph illustrating the relationship of the Si content relative to the elongation based on TABLE 3. As is clear from TABLE 3 and FIG. 12, by setting the Si content to satisfy the relationship Si≦0.25 wt %, the toughness as well as the strength of the plate-shaped main body 2 is maintained.

(3) Relationship of Mn content to mechanical properties.

TABLE 4 shows the composition, tensile strength, and elongation of test piece examples (4) and (12) to (16).

TABLE 4

| | | | | | | | Tensile | |
|---|---|---|---|---|---|---|---|---|
| Test | Chemical components (wt %) | | | | | | Strength | Elongation |
| piece | Mg | Si | Mn | Fe | Ti | Al | (MPa) | (%) |
| (12) | 4.1 | 0.2 | 0.6 | 0.2 | 0.15 | Balance | 261 | 18.3 |
| (13) | 4.1 | 0.2 | 0.8 | 0.2 | 0.15 | Balance | 276 | 17.5 |
| (4) | 4.1 | 0.2 | 1.1 | 0.2 | 0.15 | Balance | 280 | 17.0 |
| (14) | 4.1 | 0.2 | 1.5 | 0.2 | 0.15 | Balance | 284 | 15.8 |
| (15) | 4.1 | 0.2 | 1.8 | 0.2 | 0.15 | Balance | 295 | 11.9 |
| (16) | 4.1 | 0.2 | 2.0 | 0.2 | 0.15 | Balance | 302 | 10.2 |

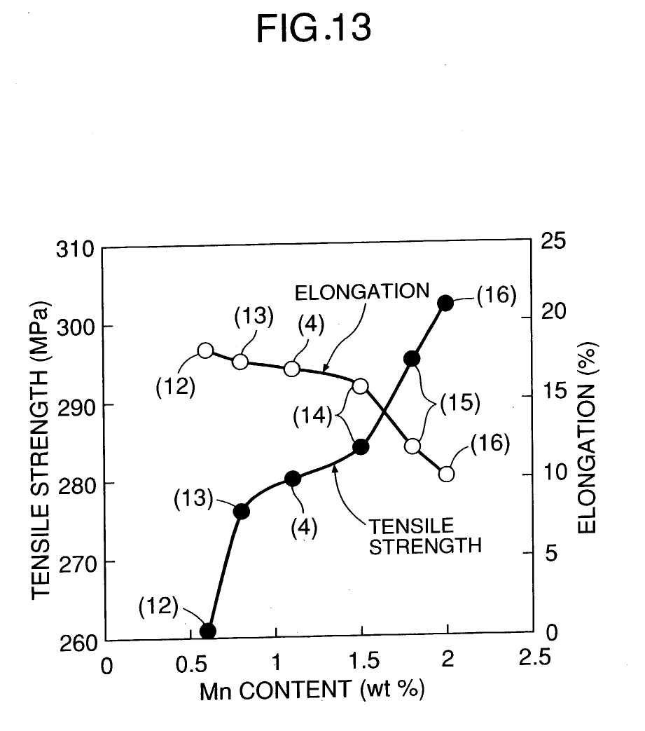

FIG. 13 is a graph illustrating the relationship of the Mn content relative to the tensile strength and elongation based on TABLE 4. As is clear from TABLE 4 and FIG. 13, by setting the Mn content at 0.8 wt %≦Mn≦1.5 wt %, the strength and toughness of the plate-shaped main body 2 is maintained. In the case of example (12), in which the Mn content was less than 0.8 wt %, there was sintering on the surface of the die.

(4) Relationship of Fe content to mechanical properties.

TABLE 5 shows the composition, tensile strength, and elongation of test piece examples (4) and (17) to (19).

TABLE 5

| | | | | | | | Tensile | |
|---|---|---|---|---|---|---|---|---|
| Test | Chemical components (wt %) | | | | | | Strength | Elongation |
| piece | Mg | Si | Mn | Fe | Ti | Al | (MPa) | (%) |
| (4) | 4.1 | 0.2 | 1.1 | 0.2 | 0.15 | Balance | 280 | 17.0 |
| (17) | 4.1 | 0.2 | 1.1 | 0.5 | 0.15 | Balance | 278 | 15.8 |
| (18) | 4.1 | 0.2 | 1.1 | 0.7 | 0.15 | Balance | 290 | 12.6 |
| (19) | 4.1 | 0.2 | 1.1 | 1.3 | 0.15 | Balance | 284 | 7.5 |

As is clear from TABLE 5, by setting the Fe content to satisfy the relationship Fe≦0.5 wt %, the strength of the plate-shaped main body 2 is maintained.

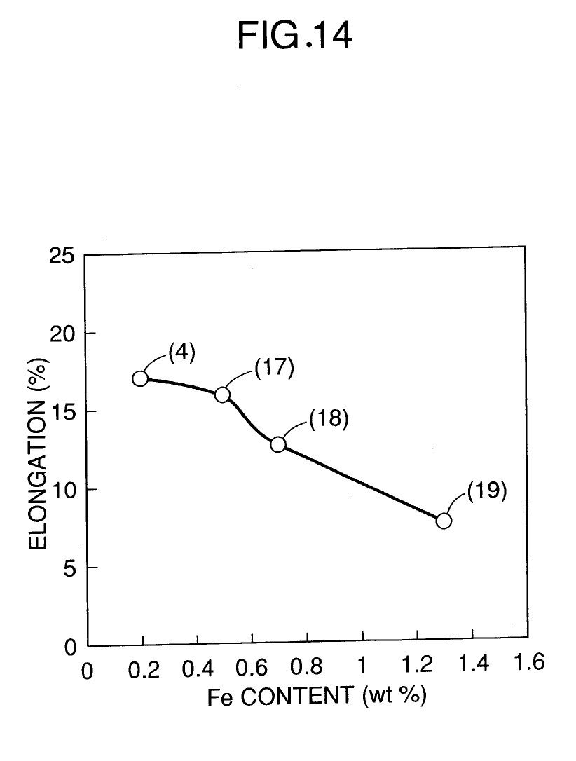

FIG. 14 is a graph illustrating the relationship between the Fe content and elongation based on TABLE 5. As is clear from TABLE 5 and FIG. 14, by setting the Fe content at Fe≦0.5 wt %, the toughness of the plate-shaped main body 2 is maintained.

(5) Relationship of Ti content to flowability.

TABLE 6 shows the composition and the flow length at 720° C. and 745° C. of test piece examples (4) and (20) to (24).

TABLE 6

| Test | Chemical components (wt %) | | | | | | Flow length (mm) | |
|---|---|---|---|---|---|---|---|---|
| piece | Mg | Si | Mn | Fe | Ti | Al | 720° C. | 745° C. |
| (20) | 4.1 | 0.2 | 1.1 | 0.2 | 0 | Balance | 662 | 715 |
| (21) | 4.1 | 0.2 | 1.1 | 0.2 | 0.05 | Balance | 668 | 718 |
| (22) | 4.1 | 0.2 | 1.1 | 0.2 | 0.10 | Balance | 684 | 746 |
| (4) | 4.1 | 0.2 | 1.1 | 0.2 | 0.15 | Balance | 685 | 750 |
| (23) | 4.1 | 0.2 | 1.1 | 0.2 | 0.30 | Balance | 682 | 761 |
| (24) | 4.1 | 0.2 | 1.1 | 0.2 | 0.35 | Balance | 674 | 723 |

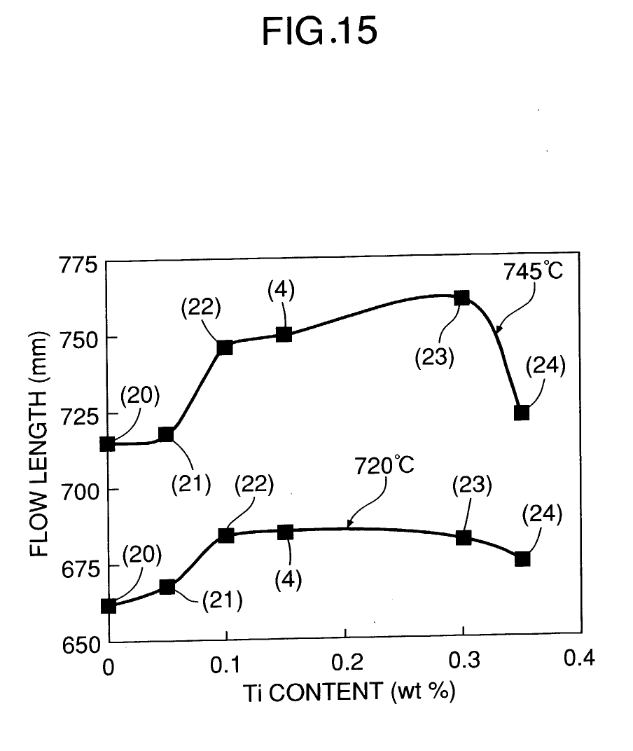

FIG. 15 is a graph illustrating the relationship between the Ti content and flow length based on TABLE 6. As is clear from TABLE 6 and FIG. 15, by setting the Ti content to satisfy the relationship 0.1 wt %≦Ti≦0.3 wt %, the flowability of the molten metal is maintained, thus preventing the occurrence of incomplete filling of the plate-shaped main body 2.

Although the preferred embodiments of the present invention have been described in detail herein, it will be understood that the present invention is not limited to the above-described embodiment, and various modifications may be made without departing from subject matter and scope of the invention recited in the following claims.

We claim:

1. A ribbed die cast product, comprising:
a plate-shaped main body having front and back surfaces; and
at least one rib provided on the back surface of the plate-shaped main body, wherein the die cast product is formed from an Al—Mg alloy,
wherein a first imaginary straight line extends in a lengthwise direction of the rib and intersects a plurality of second imaginary straight lines extending in a molten metal flow direction in the plate-shaped main body.

2. The ribbed die cast product according to claim 1, wherein an intersection angle (α) formed by the intersecting first and second imaginary straight lines satisfies a relationship wherein 25°≦α≦90°.

3. The ribbed die cast product according to claim 1, wherein the Al—Mg alloy includes 3.5 wt %≦Mg≦4.5 wt %; Si≦0.25 wt %; 0.8 wt %≦Mn≦1.5 wt %; Fe≦0.5 wt %; and 0.1 wt %≦Ti≦0.3 wt %, and a remainder of the balance being Al and a plurality of impurities.

4. The ribbed die cast product according to claim 1, wherein the plate-shaped main body comprises:
a flat portion;
a first bent portion at a first end of the flat portion;
a second bent portion at a second end of the flat portion, wherein the first bent portion is wider than the second bent portion;
a first outer edge portion extending from an end of the first bent portion; and
a second outer edge portion extending from an end of the second bent portion,
wherein the first and second bent portions bend in a same direction relative to the flat portion.

5. The ribbed die cast product according to claim 4, wherein opposite edges of the flat portion in a lengthwise direction are arc shaped.

6. The ribbed die cast product according to claim 5, further comprising a base portion provided on the back surface, the base portion dividing the back surface into substantially equal sections along the lengthwise direction.

7. The ribbed die cast product according to claim 2, wherein the Al—Mg alloy includes 3.5 wt %≦Mg≦4.5 wt %; Si≦0.25 wt %; 0.8 wt %≦Mn≦1.5 wt %; Fe≦0.5 wt %; and 0.1 wt %≦Ti≦0.3 wt %, and a remainder of the balance being Al and a plurality of impurities.

8. The ribbed die cast product according to claim 7, wherein the plate-shaped main body comprises:
a flat portion;
a first bent portion at a first end of the flat portion;
a second bent portion at a second end of the flat portion, wherein the first bent portion is wider than the second bent portion;
a first outer edge portion extending from an end of the first bent portion; and
a second outer edge portion extending from an end of the second bent portion,
wherein the first and second bent portions bend in a same direction relative to the flat portion.

9. The ribbed die cast product according to claim 8, wherein opposite edges of the flat portion in a lengthwise direction are arc shaped.

10. The ribbed die cast product according to claim 9, further comprising a base portion provided on the back surface, the base portion dividing the back surface into substantially equal sections along the lengthwise direction.
